(19) United States
(12) Patent Application Publication
(10) Pub. No.: US 2026/0269167 A1
(43) Pub. Date: Sep. 10, 2026

(54) HIGH BRIGHTNESS x-ray SOURCE

(71) Applicant: NOVA MEASURING INSTRUMENTS INC., Fremont, CA (US)

(72) Inventor: Gildardo Delgado, Livermore, CA (US)

(73) Assignee: NOVA MEASURING INSTRUMENTS INC., Fremont, CA (US)

(21) Appl. No.: 18/961,365

(22) PCT Filed: May 26, 2023
(86) PCT No.: PCT/IB2023/055397

§ 371 Date: Nov. 26, 2024

Related U.S. Application Data
(60) Provisional application No. 63/365,414, filed on May 26, 2022.
(60) Provisional application No. 63/376,770, filed on Sep. 22, 2022.

(51) Int. Cl. H01J 35/12

(52) U.S. Cl. CPC H01J 35/13

(57) ABSTRACT

A method for generating an x-ray beam, the method includes (a) directing an x-ray generating fluid towards a cryogenic x-ray emitting target; (b) freezing, by the cryogenic x-ray emitting target, the x-ray generating fluid to provide a frozen x-ray generating material; and (c) illuminating the frozen x-ray generating material with an electron beam to generate the x-ray beam.

### CROSS REFERENCE

This application claims priority from U.S. provisional patent Ser. No. 63/365,414, filing date 26 May 2022 which is incorporated herein by reference in its entirety.

### BACKGROUND OF THE INVENTION

There is a growing need to provide a high brightness x-ray source for metrology and inspection.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1-4 illustrate examples of x-ray sources that include a photocathode;

FIG. 5 illustrates an example of a method;

FIGS. 6-7 illustrate examples of electron beam to x-ray conversion optics; and

FIG. 8 illustrates an example of a method.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electron beam components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method.

Any reference in the specification to a system should be applied mutatis mutandis to a method that may be executed by the system.

There is provided a x-ray source that exhibits a high brightness (for example—having Photon flux>1×10¹⁰ ph/s) for metrology and inspection to enable:
a. Higher throughput
b. Higher quality x-ray beam
c. Alternative architectures
d. Other technologies (Dimensional Metrology, Material Metrology, Ptychography, Inspection)
e. Tunable from low to high energies (100 eV-10's KeV)

The suggested x-ray source is more cost effective than discharge or pinch-plasma based solution (also exhibit low brightness), solid tape laser produced plasma (LPP), gas jet LPP, liquid LPP and cryogenic LPP-all are too expensive to be used in metrology.

Commercially available electron beam sources such as thermionic or field emission sources can be used with some limitations. Thermionic sources are usually made of tungsten or lanthanum hexaboride (LaB₆). In thermionic emission, electrons are boiled off the material surface when the electron thermal energy is high enough to overcome the surface potential barrier. Even though thermionic emitters are widely used, they typically require elevated temperatures (e.g., >1300 K) to operate, and may have several drawbacks such as inefficient power consumption, wide energy spread, short lifetime, low current density, and limited brightness.

Other more efficient and higher brightness electron sources such as schottky emitters and cold electron field emitters sources are available. However, they are susceptible to contamination and require very high vacuums. Nevertheless, these technologies can address some of these concerns.

An x-ray source that includes a photocathode is provided and is capable of creating a high brightness x-ray source since this technology can address most of these concerns.

Photocathodes are important in accelerator physics where they are utilized in a photoinjector to generate high brightness electron beams. Electron beams generated with photocathodes are commonly used for free electron lasers and for ultrafast electron diffraction. Photocathodes are also commonly used as negatively charged electrodes in a light detection device such as a photomultiplier or phototube.

The simplest form of a x-ray source includes a photocathode and optical elements configured to receive an incident radiation beam (for example a light beam) that provides shaping, collimation and focuses on the photocathode surface.

The photocathode surface generates a high brightness electron beam with very low energy spread. The electron beam is then focused on a target to generate a high brightness x-ray beam. The target material can be chosen to optimize the x-ray energy. By carefully choosing the material, x-ray with energies from 100 eV-10's of keV are possible. This target material may also be referred to as “x-ray material”.

The optical elements of the x-ray source can focus an optical beam to diffraction limited dimensions governed by the wavelength and by the numerical aperture (NA) of the optical system. For example, for a laser system with wavelength λ, one can focus a Gaussian beam with a lens of focal length f, and beam waist wₒ to final waist

$${w}_{f} \cdot {w}_{f} = \frac{λ f}{π {w}_{o}}$$

The spot size can therefore be very small. For ultraviolet (UV) lasers this spot can be less than a micron in diameter.

A electron beam generated by the x-ray source can be shaped to any desired geometry by use of the optical elements-such as filters, or masks, or electron optics elements with the use of mask sand filters.

The photocathode emits electrons with properties that depend on the shape of the drive laser. For example, it can be a gaussian shape or a flat top beam. It can be a ring, annular, or any desire shape.

A photocathodes may be preferable to other forms of cathodes because a photocathode may have the ability to better control the quality of the electron beam that is outputted from the photocathode.

A photocathode, when struck by a light beam, emits electrons by applying the photoelectric effect. The photoelectric effect conserves the energy and the momentum of the impinging light beam. Thus, the light beam properties will be conserved in the photon electron beam. For example, a photocathode illuminated with a light beam will conserve many of the laser beam parameters such as energy spread and stability.

A photocathode of the x-ray source can be illuminated by any type of light that can be generated by various light sources such as lamps, plasmas, laser-produced plasmas, discharge plasmas, diodes or lasers.

The light beam may be continuous (for example CW) or pulsed.

The x-ray source, when using a photocathode, can maintain an energy spread or energy dispersion (of the photon electron beam) which can as small as 0.1 eV vs conventional thermal emission e guns (>1 eV) or field emission systems (>0.3 eV).

The low energy spread of the electron beam may be an important parameter to be able to make high-quality electron beams and small spot sizes with very small energy tails.

Very low levels of energy dispersion cannot be produced by the conventional electron beams. The smaller the energy dispersion the better quality of the beam and the quality of the small electron spot size. Also, the low energy dispersion will facilitate initially getting a nearly parallelized electron beam. The desired spot size of less than 200 μm diameter is preferable.

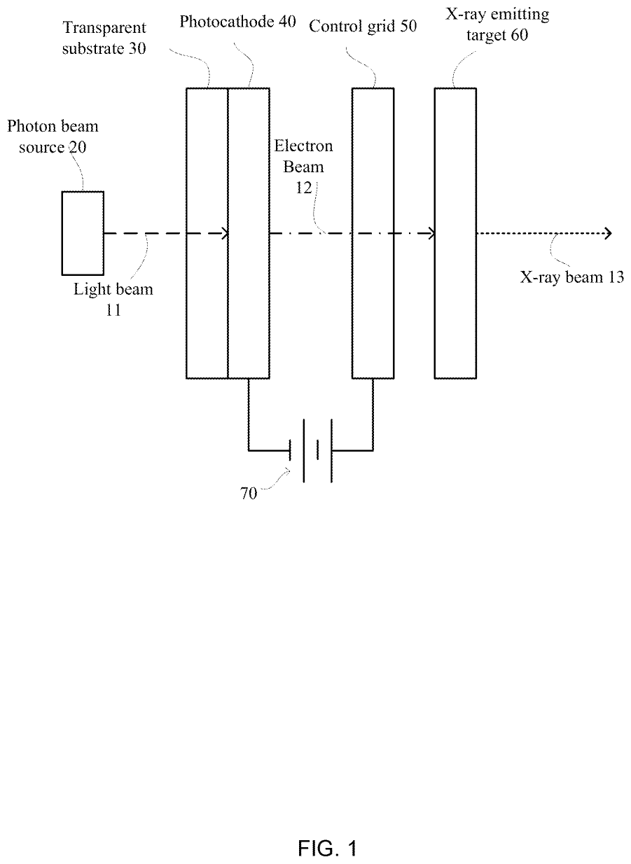

FIG. 1 illustrates a transmissive x-ray source that includes a radiation source such as photon beam source 20 such as but not limited to a laser that is configured to direct radiation (such as light beam 11) towards a transparent substrate 30 that mechanically supports a photocathode 40. The light beam 11 impinges on one side of the photocathode 40 and causes electrons to be emitted from an opposite side of the photocathode to form electron beam 12. Electron beam 12 is attracted to control grid 50 (that is biased by bias circuit 70 in relation to the photocathode 40, the bias may determine an energy of the electrons that are emitted from the control grid) and then impinges on x-ray emitting target 60 that generates x-ray beam 13.

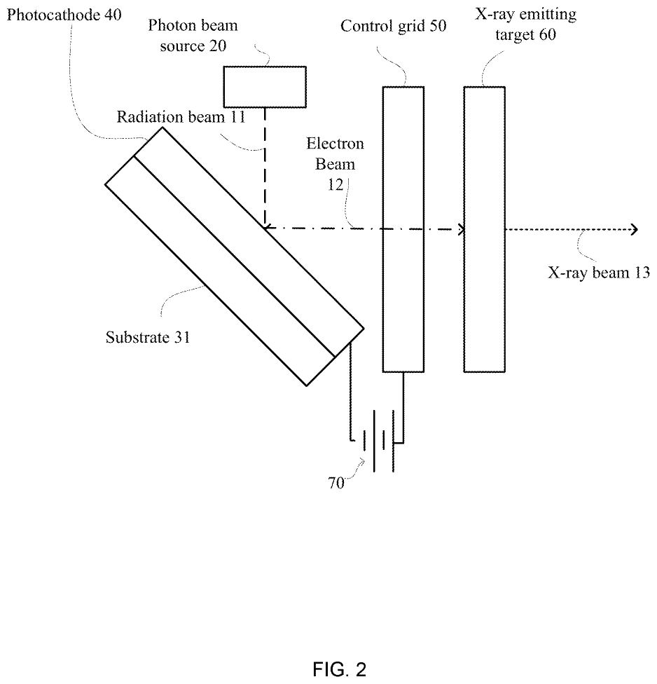

FIG. 2 illustrates a reflective x-ray source that includes a radiation source such as photon beam source 20 such as but not limited to a laser that is configured to direct radiation (such as light beam 11) towards photocathode 40. The photocathode 40 is supported by substrate 31. The light beam 11 impinges a side of the photocathode 40 and causes electrons to be emitted from the same side to form electron beam 12. Electron beam 12 is attracted to control grid 50 (that is biased by bias circuit 70 in relation to the photocathode 40, the bias may determine an energy of the electrons that are emitted from the control grid) and then impinges on x-ray emitting target 60 that generates x-ray beam 13.

Electron beam 12 is of high quality can also be shaped and focused to very small spot size by using electron beam optics (positioned between the photocathode and the x-ray material.

The electron optics may include at least some components of an electron beam column, such as one or more apertures and/or one or more deflectors and/or one or more scan coils and/or one or more electromagnetic lenses and/or one or more magnetic lenses and/or one or more detectors.

The configuration of the electron optics can vary with the particular application of the system. The electron energy range may cover 100 eV-10's of keV. Electron spot size on the x-ray material may be smaller than 50 μm.

The electron beam can then be focused on a x-ray emitting target that can be made of the x-ray material solid. The x-ray emitting target may be made of (or may include) liquid or gas to generate x-rays with a very well define x-ray spot.

While FIGS. 1 and 2 illustrate a transmissive mode x-ray emitting target—the x-ray emitting target may be a reflection mode x-ray emitting target.

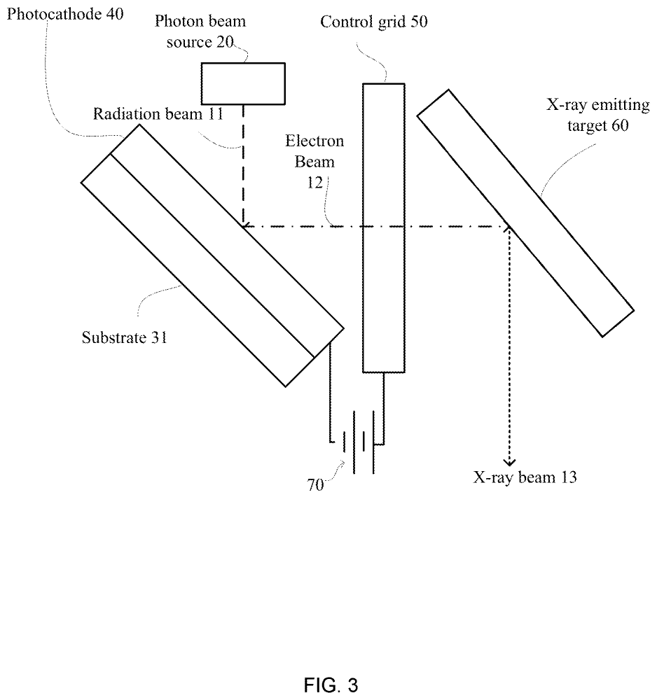

FIG. 3 illustrates an x-ray source with a reflective x-ray emitting target.

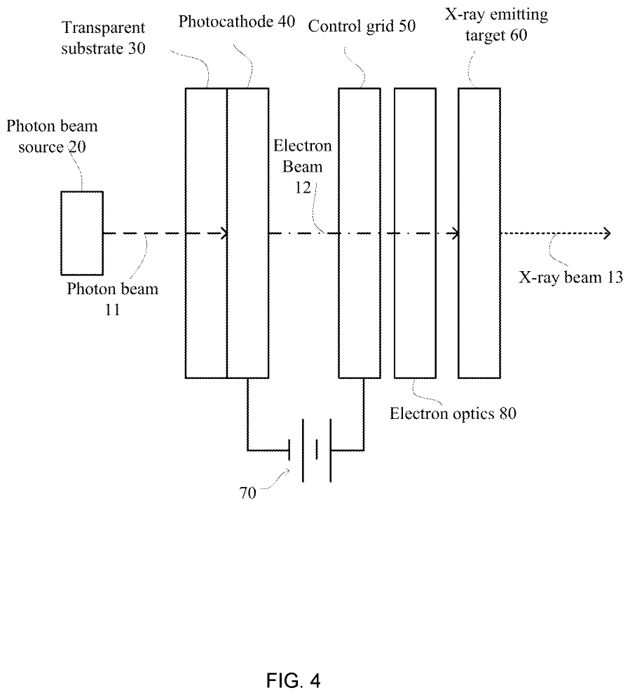

FIG. 4 illustrates an example of an x-ray source with electron optics 80 between the control grid 50 and the x-ray emitting target.

The substrate (that supports the photocathode) can be made of a material that is selected in dependency on the wavelength of the radiation beam. For example, for UV wavelengths down to 248 nm, fused silica or sapphire may be used as the substrate material. For wavelengths down to 190 nm, high-grade fused silica can be used. For wavelength below 190 nm, MgF₂ or CaF₂ may be used. The material of the photocathode can be chosen for optimal quantum efficiency (QE), energy spread, and desired lifetime at a given wavelength.

The photocathode may be chosen to produce high brightness for the wavelength of the radiation beam. For example, the photocathode material may be chosen and may have different coatings or different substrates depending on wavelength or if the configuration is in transmission vs reflection mode.

Choices for photocathode can be semiconductors, semiconductor alloys, metals, metal alloys or hybrid systems.

For example, semiconductor PC that can be used are: Cs2Te, CsK2Sb, and GaAs. Cs2Te, CsK2Sb, K2CsSb, Cs: GaAs, GaAs, AlGaN or alloys formed with of AlGaN and GaN, InGaN, InGaP, InGaP, GaP, GaN and GaP, CsI, CsBr, or alkali halide photocathodes

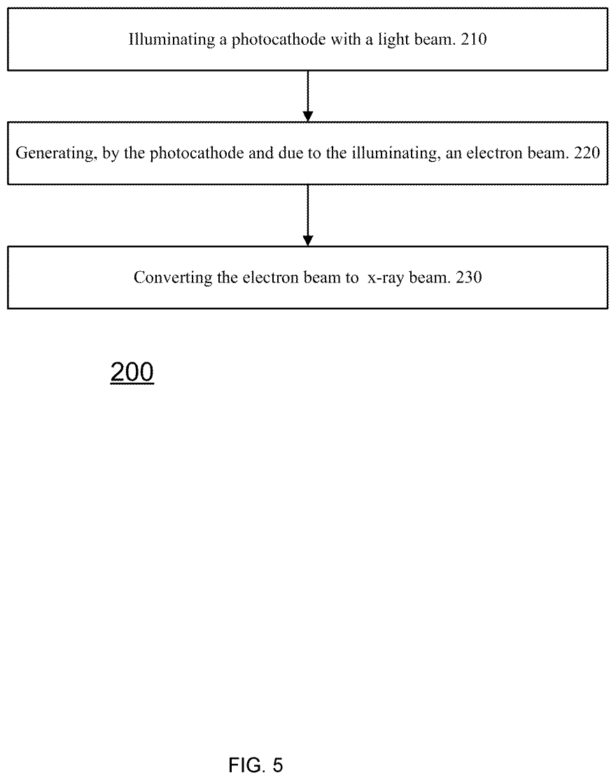

FIG. 5 illustrates an example of method 200 for generating an x-ray beam.

Method 200 may start by step 210 of illuminating a photocathode with a light beam.

Step 210 may be followed by step 220 of generating, by the photocathode and due to the illuminating, an electron beam.

Step 220 may be executed by the photocathode while operating in a transmissive mode.

Step 220 may be executed by the photocathode while operating in a reflective mode.

Step 220 may be followed by step 230 of converting the electron beam to x-ray beam.

A spot size of the light beam may be of a microscopic scale.

The electron beam may exhibit an energy spread of less than 0.3 electron volts.

The photocathode can include fused silica or sapphire. Said materials may be used as the substrate material.

The photocathode can be made of MgF₂, CaF₂, BaF₂ or LiF₂.

The photocathode can be made of at least one material out of Cs2Te, CsK2Sb, GaAs, Cs2Te, CsK2Sb, K2CsSb, Cs: GaAs, GaAs, AlGaN, one or more alloys formed with AlGaN or GaN, InGaN, InGaP, InGaP, GaP, GaN, GaP, CsI, CsBr, or alkali halide.

The light beam, the electron beam and the x-ray beam may be continuous beams or pulsed beams.

There may also be provided hybrid x-ray sources. For example, thermionic cathode materials use a thermally assisted photoemission process. For example, LaB6 or CeB6 cathodes are heated and use light sources to assist in the electron emission process. have already been successfully used as photocathodes.

Material for x-ray generation can be any of the following:
a. Gas jet, Pressurized Gas Jet.
b. Cryogenic gas, liquids or solids.
c. Solid bulk material used in reflection mode.
d. Thin films can be used in transmission or reflection mode.
e. Tape.
f. Liquid metals.

Any of the above materials in various configurations can be used to in the x-ray source. For example, gas jets are convenient target material because gas produces little debris vs liquids or solids.

Also, gas jets can easily deliver lightweight Z materials such as any lightweight organic or alcohols for example Ethanol, O2, CO2 or H2O, H2O2 etc. Low Z material deployed in gas jets can be used to generate wavelengths from photons with energies ranging from 10's of eV to 100's eV depending on the gas pressure and composition of the gas. x-ray collection can be arranged in varying angles or geometries with respect to the gas jet as depicted in FIG. 5.

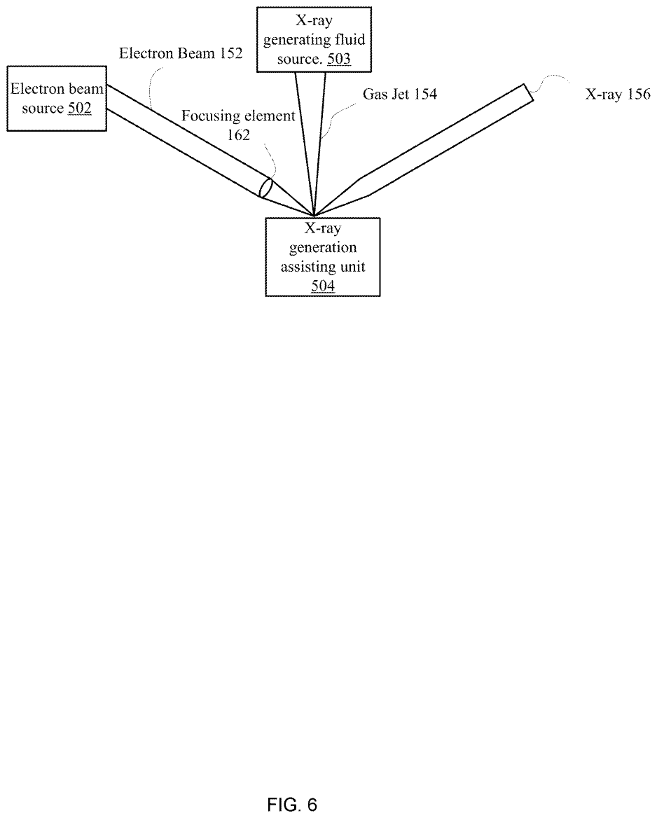

FIG. 6 illustrates an example of electron beam to x-ray conversion optics that may follow the control grid 50 of any one of FIGS. 1-4.

The electron beam to x-ray conversion optics may convert electron beam 152 (generated by electron beam source 502 and focused by focusing element 162) to a x-ray beam 156, that is assisted by a gas jet 154 (generated by x-ray generating fluid source 503) to provide materials needed from the conversion.

The x-ray beam may propagate in any angle or any other geometrical relationship in relation to the direction of propagation of the gas jet. A x-ray generation assisting unit 504 (such as cryogenic x-ray target) assists in the generation of the x-ray—for example by improving the conversion of the electron beam to the x-ray beam when using a gas jet or a liquid jet.

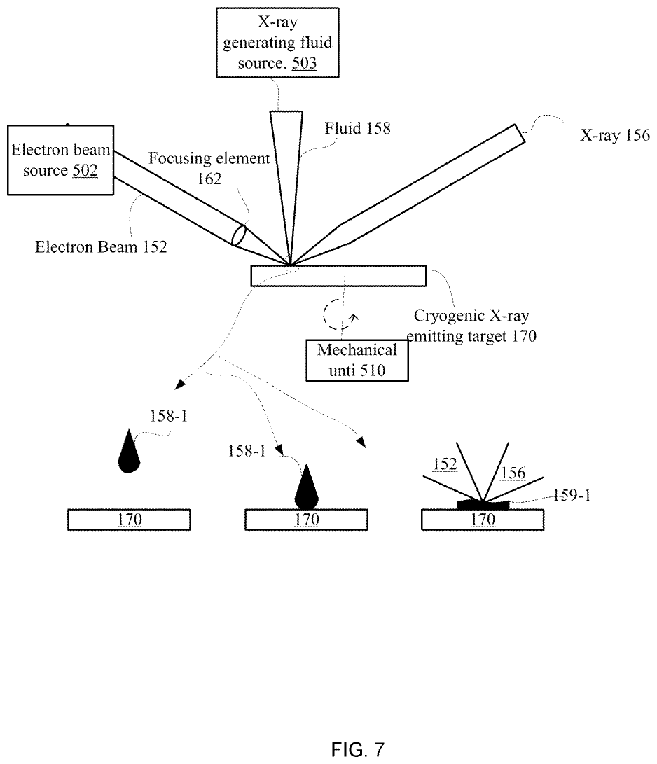

FIG. 7 illustrates a x-ray generation assisting unit such as cryogenic x-ray emitting target 170 (that may be a cryogenic solid anode) that improves the conversion by condensing (freezing) gas or liquid (from x-ray generating fluid source 503) to a denser matter (for example-solid) which includes more molecules per unit area—which causes the electron beam 152 (generated by electron beam source 502) to interact with more molecules during the electron beam to x-ray beam conversion—which improves the conversion and yields a higher brightness x-ray beam 156.

FIG. 7 also illustrates an example of (see from left to right) a drop 158-1 of fluid 158 (also referred to as a x-ray generating fluid) that approaches the cryogenic x-ray emitting target 170, contacts the cryogenic x-ray emitting target 170, and freezes to form a solid element 159-1 (also referred to as a frozen x-ray generating material) that interacts with the electron beam 152 to form the x-ray beam 156.

The interaction may slightly damage the cryogenic x-ray emitting target—and it may be beneficial to move the cryogenic x-ray emitting target (by mechanical unit 510 that may include a motor)—so that different areas of the cryogenic x-ray emitting target will be eroded over time. The movement may be rotational and/or linear. And the like.

For metrology and inspection, an x-ray beam with an energy range 10 eV-10's of keV can be generated using the electron beam to x-ray conversion optics of FIG. 7.

The illustrated above x-ray sources may provide a high brightness electron beam that exhibits a high quality and may be semi-coherent—and using such electron beam to provide a high-quality semi-coherent high brightness x-ray beam. The x-ray beam can be tunable ranging in energy from 10 eV-10 keVs. These qualities are important to enable fast acquisition times for XPS and XRF but can also enable other advanced technologies and technics for XRS such as ptychography.

These high brightness x-ray sources make possible a wide range of technologies in dimensional metrology, material characterization metrology, semiconductor inspection, battery inspection, x-ray diffraction imaging for biology or biomedical.

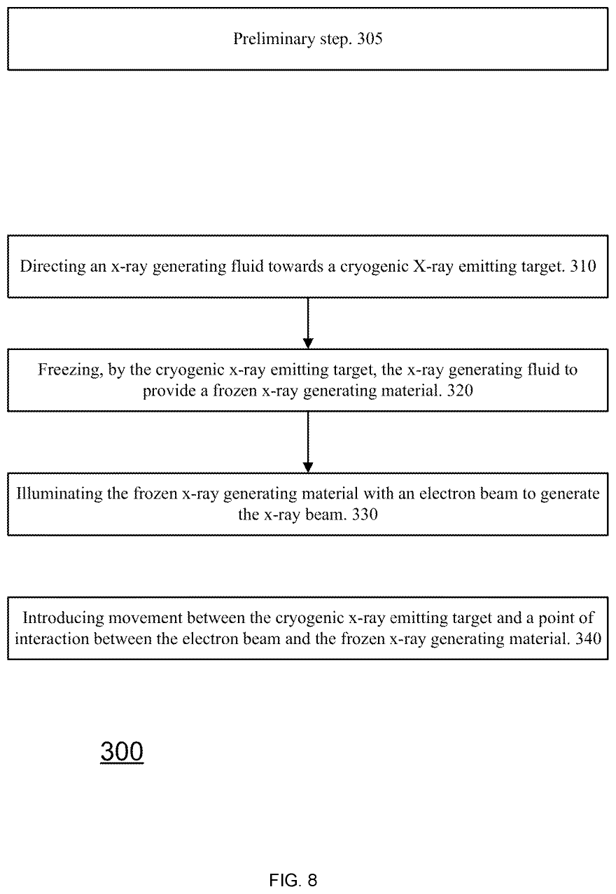

FIG. 8 illustrates an example of method 300 for generating an x-ray beam.

Method 300 may include a preliminary step 305 of generating an electron beam. The electron beam may be generated by illuminating a photocathode with a light beam. Preliminary step 305 may include receiving the electron beam.

The electron beam may be a continuous electron beam or a pulsed electron beam.

Method 300 may also include step 310 of directing an x-ray generating fluid towards a cryogenic x-ray emitting target.

The x-ray generating fluid may be a x-ray generating liquid or an x-ray generating gas.

Step 310 may be followed by step 320 of freezing, by the cryogenic x-ray emitting target, the x-ray generating fluid to provide a frozen x-ray generating material.

Method 300 may also include step 330 of illuminating the frozen x-ray generating material with an electron beam to generate the x-ray beam.

Step 330 may occur while the frozen x-ray generating material is positioned on the cryogenic x-ray emitting target.

Steps 310, 320 and 330 may be repeated multiple times.

Method 300 may include step 340 of introducing movement between the cryogenic x-ray emitting target and a point of interaction between the electron beam and the frozen x-ray generating material.

The movement may be a rotational movement of the cryogenic x-ray emitting target—or any other movement.

The x-ray beam may include one or more Kα lines and continuum energy radiation between 100 eV till tens of KeV.

There may be provided a method for generating an x-ray beam, the method may include directing an x-ray generating fluid towards a cryogenic x-ray emitting target; freezing, by the cryogenic x-ray emitting target, the x-ray generating fluid to provide a frozen x-ray generating material; and illuminating the frozen x-ray generating material with an electron beam to generate the x-ray beam.

The illuminating may occur while the frozen x-ray generating material may be positioned on the cryogenic x-ray emitting target.

The method may include introducing movement between the cryogenic x-ray emitting target and a point of interaction between the electron beam and the frozen x-ray generating material.

The introducing of the movement may include rotating the cryogenic x-ray emitting target.

The x-ray generating fluid may be a x-ray generating liquid.

The x-ray generating fluid may be a x-ray generating gas.

The method may include generating the electron beam by high brightness thermal field emitter.

The high brightness thermal field emitter may be a Schottky electron beam source.

The method may include generating the electron beam by a high brightness cold electron field emitters source.

The method may include generating the electron beam by illuminating a photocathode with a beam selected out of a light beam and a laser beam.

The electron beam may be a continuous electron beam.

The electron beam may be a pulsed electron beam.

The x-ray beam may include one or more Kα lines and continuum energy radiation between 100 eV till tens of KeV.

There may be provided a x-ray beam source that may include an x-ray generating fluid source that may be configured to direct an x-ray generating fluid towards a cryogenic x-ray emitting target; a cryogenic x-ray emitting target that may be configured to freeze the x-ray generating fluid to provide a frozen x-ray generating material; and an electron beam source that may be configured to illuminate the frozen x-ray generating material with an electron beam to generate the x-ray beam.

The electron beam source may be configured to illuminate the frozen x-ray generating material while the frozen x-ray generating material may be positioned on the cryogenic x-ray emitting target.

The x-ray beam source may include a mechanical unit configured to introduce movement between the cryogenic x-ray emitting target and a point of interaction between the electron beam and the frozen x-ray generating material.

The mechanical unit may be configured to rotate the cryogenic x-ray emitting target.

The x-ray generating fluid may be a x-ray generating liquid.

The x-ray generating fluid may be a x-ray generating gas.

The electron beam source may include a high brightness thermal field emitter.

The high brightness thermal field emitter may be a Schottky electron beam source.

The electron beam source may include a high brightness cold electron field emitters source.

The electron beam source may include a photocathode and a beam source that may be configured to illuminate the photocathode by a beam selected out of a light beam and a laser beam.

The electron beam may be a continuous electron beam.

The electron beam may be a pulsed electron beam.

The x-ray beam may include one or more Kα lines and continuum energy radiation between 100 eV till tens of KeV.

There may be provided a method for generating an x-ray beam, the method may include illuminating a photocathode with a photon beam selected of a light beam and a laser beam; generating, by the photocathode and due to the illuminating, an electron beam; and converting the electron beam to x-ray beam.

The diameter of the photon beam does not exceed 200 microns.

The photocathode may be a transmissive photocathode.

The photocathode may be a reflective photocathode.

The electron beam exhibits an energy spread of less than 0.5 electron volts.

The photocathode may be made of fused silica or sapphire may be used as the substrate material.

The photocathode substrate may be made of MgF₂, CaF₂, BaF₂ or LiF₂.

The photocathode may be made of at least one material out of Cs2Te, CsK2Sb, GaAs, Cs2Te, CsK2Sb, K2CsSb, Cs: GaAs, GaAs, AlGaN, one or more alloys formed with AlGaN or GaN, InGaN, InGaP, InGaP, GaP, GaN, GaP, CsI, CsBr, or alkali halide.

The photon beam, the electron beam and the x-ray beam may be continuous beams.

The photon beam, the electron beam and the x-ray beam may be pulsed beams.

There may be provided a x-ray source that may include a photon beam source that may be configured to illuminate a photocathode with a photon beam selected of a light beam and a laser beam; wherein the photocathode may be configured to generate, due to the illumination, an electron beam; and an electron beam to x-ray beam converter that may be configured to convert the electron beam to x-ray beam.

The diameter of the photon beam does not exceed 200 microns.

The photocathode may be a transmissive photocathode.

The photocathode may be a reflective photocathode.

The electron beam exhibits an energy spread of less than 0.5 electron volts.

The photocathode may be made of fused silica or sapphire.

The photocathode substrate may be made of MgF₂, CaF₂, BaF₂ or LiF₂

The photocathode may be made of at least one material out of Cs2Te, CsK2Sb, GaAs, Cs2Te, CsK2Sb, K2CsSb, Cs: GaAs, GaAs, AlGaN, one or more alloys formed with AlGaN or GaN, InGaN, InGaP, InGaP, GaP, GaN, GaP, CsI, CsBr, or alkali halide.

The photon beam, the electron beam and the x-ray beam may be continuous beams.

The photon beam, the electron beam and the x-ray beam may be pulsed beams.

There may be provided a method for generating an x-ray beam, the method may include illuminating an x-ray target with high brightness thermal field emitter electron beam source; and converting, by the x-ray target, the electron beam to X-ray beam.

There may be provided a method for generating an x-ray beam, the method may include illuminating an x-ray target with high brightness Cold Field Emitter electron beam source; and converting, by the x-ray target, the electron beam to x-ray beam.

There may be provided a non-transitory computer readable that stores instructions that once executed by a controller (for example a controller having an integrated circuit) causes the controller to control an execution of any method illustrated in the application.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

Any reference to comprising should be applicable, mutatis mutandis to “consisting” and be applicable, mutatis mutandis to “consisting essentially of”.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for generating an x-ray beam, the method comprises:
directing an x-ray generating fluid towards a cryogenic x-ray emitting target;
freezing, by the cryogenic x-ray emitting target, the x-ray generating fluid to provide a frozen x-ray generating material;
illuminating the frozen x-ray generating material with an electron beam to generate the x-ray beam.

2. The method according to claim 1, wherein the illuminating occurs while the frozen x-ray generating material is positioned on the cryogenic x-ray emitting target.

3. The method according to claim 1, comprising introducing movement between the cryogenic x-ray emitting target and a point of interaction between the electron beam and the frozen x-ray generating material.

4. The method according to claim 3, wherein the introducing of the movement comprises rotating the cryogenic x-ray emitting target.

5. The method according to claim 1, wherein the x-ray generating fluid is a x-ray generating liquid.

6. The method according to claim 1, wherein the x-ray generating fluid is a x-ray generating gas.

7. The method according to claim 1, comprising generating the electron beam by high brightness thermal field emitter.

8. The method according to claim 7, wherein the high brightness thermal field emitter is a Schottky electron beam source.

9. The method according to claim 1, comprising generating the electron beam by a high brightness cold electron field emitters source.

10. The method according to claim 1, comprising generating the electron beam by illuminating a photocathode with a beam selected out of a light beam and a laser beam.

11. The method according to claim 1, wherein the electron beam is a continuous electron beam.

12. The method according to claim 1, wherein the electron beam is a pulsed electron beam.

13. The method according to claim 1, wherein the x-ray beam comprises one or more Kα lines and continuum energy radiation between 100 eV till tens of KeV.

14. A x-ray beam source, comprising:
an x-ray generating fluid source that is configured to direct an x-ray generating fluid towards a cryogenic x-ray emitting target;
a cryogenic x-ray emitting target that is configured to freeze the x-ray generating fluid to provide a frozen x-ray generating material;
an electron beam source that is configured to illuminate the frozen x-ray generating material with an electron beam to generate the x-ray beam.

15. The x-ray beam source according to claim 14, wherein the electron beam source is configured to illuminate the frozen x-ray generating material while the frozen x-ray generating material is positioned on the cryogenic x-ray emitting target.

16. The x-ray beam source according to claim 14, comprising a mechanical unit configured to introduce movement between the cryogenic x-ray emitting target and a point of interaction between the electron beam and the frozen x-ray generating material.

17. The x-ray beam source according to claim 16, wherein the mechanical unit is configured to rotate the cryogenic x-ray emitting target.

18. The x-ray beam source according to claim 14, wherein the x-ray generating fluid is a x-ray generating liquid.

19. The x-ray beam source according to claim 14, wherein the x-ray generating fluid is a x-ray generating gas.

20. The x-ray beam source according to claim 14, wherein the electron beam source comprises a high brightness thermal field emitter.

21. The x-ray beam source according to claim 20, wherein the high brightness thermal field emitter is a Schottky electron beam source.

22. The x-ray beam source according to claim 14, wherein the electron beam source comprises a high brightness cold electron field emitters source.

23. The x-ray beam source according to claim 14, wherein the electron beam source comprises a photocathode and a beam source that is configured to illuminate the photocathode by a beam selected out of a light beam and a laser beam.

24. The x-ray beam source according to claim 14, wherein the electron beam is a continuous electron beam.

25. The x-ray beam source according to claim 14, wherein the electron beam is a pulsed electron beam.

26. The x-ray beam source according to claim 14, wherein the x-ray beam comprises one or more Kα lines and continuum energy radiation between 100 eV till tens of KeV.

27. A method for generating an x-ray beam, the method comprises:
illuminating a photocathode with a photon beam selected of a light beam and a laser beam;
generating, by the photocathode and due to the illuminating, an electron beam; and
converting the electron beam to x-ray beam.

28. The method according to claim 27, wherein a diameter of the photon beam does not exceed 200 microns.

29. The method according to claim 27, wherein the photocathode is a transmissive photocathode.

30. The method according to claim 27, wherein the photocathode is a reflective photocathode.

31. The method according to claim 27, wherein the electron beam exhibits an energy spread of less than 0.5 electron volts.

32. The method according to claim 27, wherein the photocathode is made of fused silica or sapphire may be used as the substrate material.

33. The method according to claim 27, wherein the photocathode substrate is made of MgF₂, CaF₂, BaF₂ or LiF₂.

34. The method according to claim 27, wherein the photocathode is made of at least one material out of Cs2Te, CsK2Sb, GaAs, Cs2Te, CsK2Sb, K2CsSb, Cs:GaAs, GaAs, AlGaN, one or more alloys formed with AlGaN or GaN, InGaN, InGaP, InGaP, GaP, GaN, GaP, CsI, CsBr, or alkali halide.

35. The method according to claim 27, wherein the photon beam, the electron beam and the x-ray beam are continuous beams.

36. The method according to claim 27, wherein the photon beam, the electron beam and the x-ray beam are pulsed beams.

37. An x-ray source, comprising:
a photon beam source that is configured to illuminate a photocathode with a photon beam selected of a light beam and a laser beam; wherein the photocathode is configured to generate, due to the illumination, an electron beam; and
an electron beam to x-ray beam converter that is configured to convert the electron beam to x-ray beam.

38. The x-ray source according to claim 27, wherein a diameter of the photon beam does not exceed 200 microns.

39. The x-ray source according to claim 27, wherein the photocathode is a transmissive photocathode.

40. The x-ray source according to claim 27, wherein the photocathode is a reflective photocathode.

41. The x-ray source according to claim 27, wherein the electron beam exhibits an energy spread of less than 0.5 electron volts.

42. The x-ray source according to claim 27, wherein the photocathode is made of fused silica or sapphire.

43. The x-ray source according to claim 27, wherein the photocathode substrate is made of MgF₂, CaF₂, BaF₂ or LiF₂.

44. The x-ray source according to claim 27, wherein the photocathode is made of at least one material out of Cs2Te, CsK2Sb, GaAs, Cs2Te, CsK2Sb, K2CsSb, Cs:GaAs, GaAs, AlGaN, one or more alloys formed with AlGaN or GaN, InGaN, InGaP, InGaP, GaP, GaN, GaP, CsI, CsBr, or alkali halide.

45. The x-ray source according to claim 27, wherein the photon beam, the electron beam and the x-ray beam are continuous beams.

46. The x-ray source according to claim 27, wherein the photon beam, the electron beam and the x-ray beam are pulsed beams.

47. A method for generating an x-ray beam, the method comprises:
illuminating an x-ray target with high brightness thermal field emitter electron beam source; and
converting, by the x-ray target, the electron beam to x-ray beam.

48. A method for generating an x-ray beam, the method comprises:
illuminating an x-ray target with high brightness Cold Field Emitter electron beam source; and converting, by the x-ray target, the electron beam to x-ray beam.
